(19) United States
(12) Patent Application Publication
(10) Pub. No.: US 2017/0001319 A1
(43) Pub. Date: Jan. 5, 2017

(54) SCISSORS

(71) Applicant: HANGZHOU GREAT STAR TOOLS CO., LTD., Hangzhou City, Zhejiang Province (CN)

(72) Inventor: Weiyi WANG, Hangzhou City (CN)

(73) Assignee: JANGZHOU GREAT STAR INDUSTRIAL CO., LTD., Hangzhou City, Zhejiang Provincw (CN)

(21) Appl. No.: 14/369,971

(22) PCT Filed: Mar. 12, 2014
(86) PCT No.: PCT/CN2014/073296

§ 371 Date: Dec. 31, 2014

(51) Int. Cl. B26B 13/16; B23D 29/02; A01G 3/02

(52) U.S. Cl. CPC B26B 13/16; A01G 3/02; B23D 29/02

(57) ABSTRACT

The present invention provides a pair of scissors comprising handle assembly and scissor head assembly. The handle assembly comprises a first handle and a second handle, and the scissor heads comprise a first scissor head and a second scissor head. The first scissor head is provided with a first blade extending from one end of the first handle. The second scissor head is provided with a second blade extending from one end of the second handle. The first scissor head and the second scissor head are pivotally hinged via a pivot structure, characterized in that, at the connection portion of the scissor head and the pivot structure, a width-thickness ratio of the first scissor head and the second scissor head is small. Such scissors enhances the rigidity of the scissor head greatly and improves the shearing strength of the scissors, facilitating snipping thicker objects to meet the requirements of being suited for various operation subjects.

### FIELD OF THE INVENTION

The present invention relates to the technical field of the mechanical tool, and more particularly, to a pair of scissors.

### DESCRIPTION OF THE PRIOR ART

In the technical field of the mechanical tool, scissors is a common hand tool. An operator applies pressure on the first handle and the second handle of the scissors to realize the relative movement between the first scissor head and the second scissor head, and the blade of the scissor head assembly act on the object to snip off objects. After the application of the pressure, the operator needs to apply tension on the first scissor head and the second scissor head in order to separate a certain distance between them. In order to facilitate the operation, a person skilled in the art improves the scissors to mount an external spring between the first handle and the second handle, which, on the one hand, makes the spring produce a force against the pressure, thus making the shearing pressure from the cutting edge of the scissor head assembly to objects more even when pressure is applied, and on the other hand, after the pressure, the first handle and the second handle rebound automatically to separate a certain distance between the first scissor head and the second scissor head under the action of the spring.

However, the scissor head assembly of this scissors is generally manufactured by plate stamping, and the plate stamping process generally requests that the width-thickness ratio of the stamping part is about 1.0, and a greater ratio is better for processing, which makes the thickness of the scissor head portion substantially uniform except the blades, and the width-thickness ratio of the scissor head assembly is relatively large, with a relatively blunt top of the blades and a bulky shape. Such scissor head assembly needs a bigger operating space and cannot meet the operating demand of the narrow portion. Moreover, the shearing strength of the blade of the scissor head assembly is limited so that it is difficult to snip a thicker object. As it can be seen, the scissor head assembly requests that it is the sharper the better, and the contradiction between the two cannot be solved by the stamping process. The scissor head assembly must be stamped first, and then be processed by other processing technical in order to achieve the operating requirement of the scissors. Thus, in order to increase the shearing strength, the cost of the existing technology is relatively high. And the space occupied by the entire scissors is large because the outside spring is mounted between the first handle and the second handle. The external spring is easy to damage, and then would impact the working life of the scissors. When shearing objects, a greater force applied on the first handle and the second handle is needed to overcome the resistance of the spring.

Thus, the person skilled in the art devotes to develop a pair of scissors with a more compact structure, better effect of shearing pressure and more comfortable operation.

### SUMMARY OF THE INVENTION

For the above-mentioned problems in the existing technology, the present invention provides a pair of scissors.

In order to achieve the purpose, the present invention provides a pair of scissors including handle assembly and scissor head assembly. The handle assembly includes a first handle and a second handle, and the scissor head assembly includes a first scissor head and a second scissor head. The first scissor head, extending from one end of the first handle, is provided with a first blade. The second scissor head, extending from one end of the second handle, is provided with a first blade. The first scissor head and the second scissor head are pivotally hinged via a pivot structure, characterized in that, the width-thickness ratio of the first scissor head located at the connection portion of the scissor head assembly and the pivot structure does not exceed 8.0, wherein the width-thickness ratio means the ratio of the width of the scissor head assembly to the thickness.

Preferably, at the connection portion of the scissor head assembly and the pivot structure, the width-thickness ratio of the first scissor head does not exceed 6.0. More preferably, at the connection portion of the scissor head assembly and the pivot structure, the width-thickness ratio of the first scissor head does not exceed 4.0.

Preferably, at the connection portion of the scissor head assembly and the pivot structure, the width-thickness ratio of the second scissor head does not exceed 8.0.

Preferably, at the connection portion of the scissor head assembly and the pivot structure, the width-thickness ratio of the second scissor head does not exceed 6.0. More preferably, at the connection portion of the scissor head and the pivot structure, the width-thickness ratio of the second scissor head does not exceed 4.0.

Preferably, the first scissor head and the second scissor head are manufactured by forging.

Preferably, the thickness of the scissor head assembly located in the pivot connection portion is 3-8 mm. Preferably, the thickness of the scissor head assembly located in the pivot connection portion is 4-6 mm. More preferably, the thickness of the scissor head assembly located in the pivot connection portion is 5 mm.

Preferably, the first scissor head is integrated with the first handle; the second scissor head is integrated with the second handle.

Preferably, teeth are arranged on the first blade and/or the second blade.

Preferably, the scissors are provided with a torsional spring which is located between the first scissor head and the second scissor head. The torsional spring does not produce deformations without external force applied on the handle assembly, and the torsional spring produce deformation when external force is applied on the handle assembly.

More preferably, the torsional spring includes a ring-shaped part, a first extension and a second extension. A first groove is arranged on the first scissor head and a second groove is arranged on the second scissor head. A part of the ring-shaped part of the torsional spring and the first extension are embedded in the first groove, and the other part of the ring-shaped part of the torsional spring and the second extension are embedded in the second groove.

Preferably, the pivot structure includes a bolt and a nut. A first hole is arranged in the first groove and a second hole is arranged in the second groove. The first hole and the second hole correspond to each other. The bolt fixed with nut is arranged in the scissors through the first hole and the second hole.

More preferably, a spacer with a through hole is arranged on the pivot structure. The bolt, through the first hole, the second hole and the through hole of the spacer, is fixed by the nut. A concave-convex texture is arranged on the spacer in order to increasing friction between the spacer and the nut to improve the fastening effect of the bolt.

Preferably, the coating is coated on the first handle and the second handle.

Preferably, a first blade and a first periphery corresponding to the first blade are arranged on the first scissor head. A pointed-shape head is arranged between the first blade and the first periphery; the second blade and a second periphery corresponding to the second blade are arranged on the second scissor head. A pointed-shape head is arranged between the second blade and the second periphery.

More preferably, the width-thickness ratio of the pointed-shape head of the first scissor head does not exceed 0.5. The width-thickness ratio of the pointed-shape head is the ratio of the width of the pointed-shape head to thickness.

More preferably, the width-thickness ratio of the pointed-shape head of the second scissor head does not exceed 0.5. As it can be seen, under the same requirement of the rigidity, the head of the scissor head assembly of the scissors in the present invention is able to be manufactured with a narrower width and a greater thickness compared with the exceeding, which is a pointed-shaped head.

Preferably, the thickness of the portion between the first blade and the first periphery is greater than that of the first periphery, and the thickness of the portion between the second blade and the second periphery is greater than that of the second periphery.

More preferably, planes with different gradients respectively from inside to outside are arranged on the portion between the first blade and the first periphery of the first scissor head. From inside to outside means the direction of the blade to the corresponding periphery of the scissor head. The gradient means the angle between the plane of the scissor head assembly and the blade.

More preferably, the planes with different gradients respectively from inside to outside are arranged on the portion between the second blade of the second scissor head and the second periphery. From inside to outside means the direction of the blade to the corresponding periphery of the scissor head assembly.

Further, the planes with the different gradients of the first scissor head are provided with the different width-thickness ratio.

Further, the planes with the different gradients of the second scissor head are provided with the different width-thickness ratio.

Further, a first plane, a second plane, a third plane and a fourth plane with different gradients from inside to outside are arranged on the portion between the first blade and the first periphery of the first scissor head respectively.

Even further, the structure of the second scissor head is the same as that of the first scissor head.

Preferably, a positioning member with a first end and a second end is arranged on the second scissor head or the second handle. The first end of the positioning member is pivotally connected with the second scissor head or the second handle. The second end of the positioning member is arranged such that when the first scissor head is aligned with the second scissor head, the second end of the positioning member rotates about the first end and abuts against the first scissor head, preventing the first scissor head to rotate.

### Technical Effect

The scissors provided in the present invention are manufactured by forging. It makes the scissor head assembly with the pointed-shaped head in order to reach into the narrow operation spaces. The scissor head assembly with a small width-thickness ratio enormously increases the rigidity of the scissor head assembly and increases the shearing strength for snipping off thicker objects. The portion between the blade of the scissor head assembly and the periphery is thickened, further to increase the durability of the scissor head assembly.

A built-in spring is arranged on the scissors provided in the present invention, which makes the torsional spring less easy to damage, with a simple entire shape and a compact structure. When shearing objects, a proper force applied on the first handle and the second handle can overcome the resistance of the spring, which is comfortable to use. After ceasing the force on the handle assembly, the torsional spring restores to the original shape, thus to separate the first scissor head and the second scissor head for next operating.

The positioning member is further arranged on the scissors in the present invention. The first scissor head and the second head can be closed for carrying when the scissors is not in use.

Referencing now to the figures, the conception, detailed structure and induced technical effect of the present invention will be expounded for due understanding of the purpose, characterizations and effects of the present invention:

### BRIEF DESCRIPTION OF THE DRAWINGS

FIG. 1 is a schematic top view of a better embodiment in the present invention.

FIG. 2 is the bottom view of the scissors in the FIG. 1.

FIG. 3 is the structure schematic view of the first scissor head and the first handle of the scissors of a better embodiment in the present invention.

FIG. 4 is the structure schematic view in the second scissor head and the second handle of the scissors of a better embodiment in the present invention.

FIG. 5 is the structure schematic view of the torsional spring of the scissors of a better embodiment in the present invention.

FIG. 6 is the structure schematic view of the scissors of a better embodiment in the present invention.

### DETAILED DESCRIPTION OF THE PREFERRED EMBODIMENTS

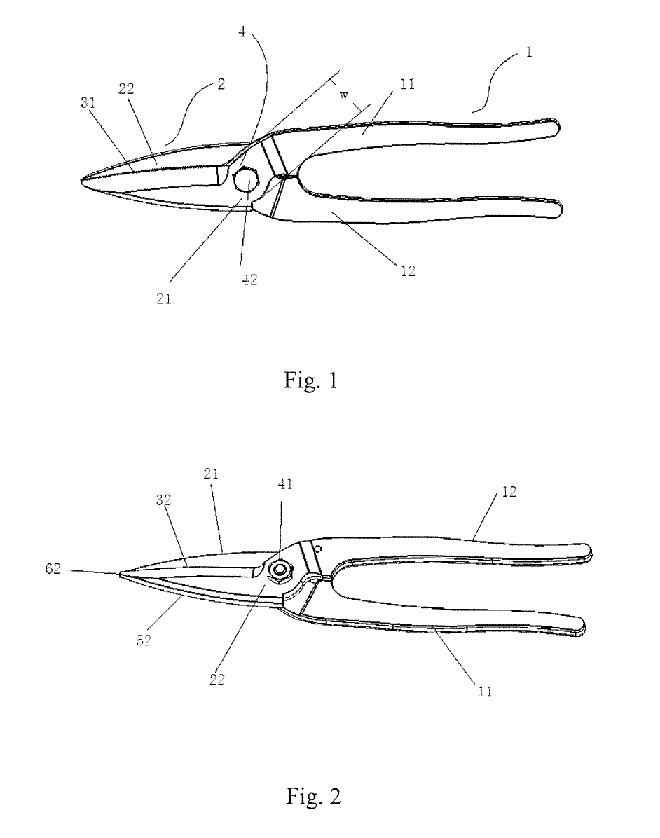

FIG. 1 and FIG. 2 are the structure schematic views of the scissors of a preferred embodiment in the present invention. In this embodiment, the scissors include a handle assembly 1 and a scissor head assembly 2. The handle assembly 1 includes a first handle 11 and a second handle 12, and the scissor head 2 includes a first scissor head 21 and a second scissor head 22. The first scissor head 21 is provided with a first blade 31 and extends from one end of the first handle 11. The second scissor head 22 is provided with a second blade 12 and extends from one end of the second handle 12. The first scissor head 21 and the second scissor head 22 are pivotally hinged via a pivot structure 4. At the connection portion of the scissor head assembly 2 and the pivot structure 4, the width-thickness ratio of the first scissor head 21 does not exceed 8.0, wherein the width-thickness ratio means the ratio of the width w of the scissor head to the thickness. Preferably, at the connection portion of the scissor head assembly 2 and the pivot structure 4, the width-thickness ratio of the first scissor head 21 does not exceed 6.0. More preferably, at the connection portion of the scissor head assembly 2 and the pivot structure 4, the width-thickness ratio of the first scissor head 21 does not exceed 4.0.

At the connection portion of the scissor head assembly 2 and the pivot structure 4, the width-thickness ratio of the second scissor head 22 does not exceed 8.0. Preferably, at the connection portion of the scissor head assembly 2 and the pivot structure 4, the width-thickness ratio of the second scissor head 22 does not exceed 6.0. More preferably, at the connection portion of the scissor head assembly 2 and the pivot structure 4, the width-thickness ratio of the second scissor head 22 does not exceed 4.0.

A blade and a periphery opposite to the blade are arranged on each scissor head.

In this embodiment, the first scissor head 21 and the second scissor head 22 are manufactured by forging. Preferably, the thickness of the part that the first scissor head 21 and the second scissor head 22 locate in the pivot connection portion is 3-8 mm. More preferably, the thickness of the part that the first scissor head 21 and the second scissor head 22 locate in the pivot connection portion is 4-6 mm. The most preferably, the thickness of the part that the first scissor head 21 and the second scissor head locate in the pivot connection portion is 5 mm.

The pivot structure 4 includes a bolt 41 and a nut 42.

In this embodiment, the scissor head assembly with a small width-thickness ratio enormously increases the rigidity of the scissor head assembly and increases the shearing strength for snip off thicker objects. Adopting forging technology can increase the thickness and rigidity of the scissor head assembly and decrease the width-thickness ratio of the scissor head assembly, and can also mark a logo on the scissor head assembly, which increases the user's impact to the information such like the product brand with remained rigidity of the scissor head assembly. It is not available in the scissors manufactured by traditional plate stamping.

The spacer 43 with a through hole is arranged on the pivot structure 4. A bolt 41 is fixed with a nut 42 through the first scissor head 21, the second scissor head 22 and the through-hole of the spacer 43. The concave-convex texture is arranged on the spacer 43 in order to increasing the friction between the spacer 43 and the nut 42 to improve the fastening effect of the pivot structure. Further, two spacers both with though hole can be arranged on the pivot structure 4. The bolt 41 is fixed with the nut 42 through the through-hole of the first spacer, the first scissor head 21, the second scissor head 22 and the through-hole of the second spacer, in order to further improve the fastening effect of the pivot structure.

The first blade 31 and the first periphery 51 which is opposite to the first blade are arranged on the first scissor head 21. A pointed-shape head 61 is arranged between the first blade 31 and the first periphery 51. The second blade 32 and the second periphery 52 which is opposite to the second blade are arranged on the second scissor head 22, the pointed-shape head 62 is arranged between the second blade 32 and the second periphery 52.

The width-thickness ratio of the pointed-shape head 61 of the first scissor head 21 does not exceed 0.5. The width-thickness ratio of the pointed-shape head 62 of the second scissor head 22 does not exceed 0.5.

The pointed-shaped head of the scissor head assembly is able to reach into the narrow operation spaces to meet the different operation requirement. Meanwhile, compared with the head portion of the scissor head assembly manufactured by traditional plate stamping, the scissor head assembly with a small width-thickness ratio in this embodiment enormously increases the rigidity of the scissor head and enhances the shearing strength for snipping off thicker objects to meet the requirements of various operation subjects.

In a preferable embodiment of the present invention, the thickness of the portion between the first blade 31 and the first periphery 51 is greater than that of the first periphery. The thickness of the portion between the second blade 32 and the second periphery 52 is greater than that of the second periphery. Different from the scissors manufactured by traditional plate stamping, thickening the portion between the blade of the scissor head assembly and the periphery increases the rigidity of the scissor head assembly enormously and further increases the durability degree of the scissor head assembly and the shearing strength for snipping off thicker objects, adapting different shearing pressure requirements.

The thickened portion between the blade and the periphery of the scissor head assembly can be constituted by the planes with different gradients and width-thickness ratios. The portion between the first blade 31 and the first periphery 51 of the first scissor head is respectively provided with the planes with different gradients from inside to outside. Similarly, the portion between the second blade 32 and the second periphery 52 of the second scissor head is provided with planes with different gradients respectively from inside to outside. From inside to outside means the direction of the blade to the corresponding periphery of the scissor head assembly. The gradient means the angle between the plane of the scissor head assembly and the blade.

In the present invention, planes with different width-thickness ratios and gradients are arranged on the portion between the blade and the periphery, which more reasonably designs the feature of rigidity of the different portion of the scissors and optimizes the mechanical property of the scissors when the scissor head assembly is exerting the force. The scissors adopting this design is able to cut relatively thick metal, tree branches, etc. even provided with exquisite structure.

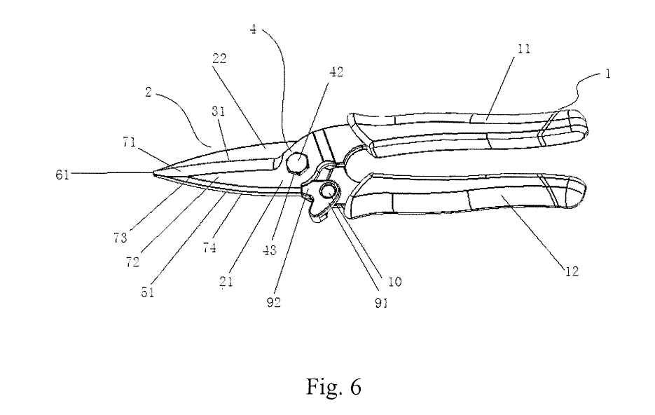

FIG. 6 shows the scissors of a better embodiment in the present invention. A first plane 71, a second plane 72, a third plane 73 and a fourth plane 74 with different gradients respectively from inside to outside are arranged on the portion between the first blade 31 of the first scissor head and the first periphery 51. The width-thickness ratio of the first plane does not exceed 3.5; the width-thickness ratio of the second plane does not exceed 3.2; the width-thickness ratio of the third plane does not exceed 3, and the width-thickness ratio of the fourth plane does not exceed 2.5. The gradient of the first plane is 30°; the gradient of the first plane is 10°; the gradient of the first plane is 3°, and the gradient of the first plane is 35°.

The structure of the second scissor head is the same as that of the first scissor head.

The scissor head assembly of the present invention is arranged with planes with different width-thickness ratios and gradients on the portion between the blade and the periphery thereof, in which the rigidity properties of the different portions of the scissors are more reasonably designed and the mechanical property of the scissors when the scissor head assembly is exerting the force is optimized. The scissors adopting such design, even with exquisite structure, is able to cut relatively thick metal, tree branches, etc.

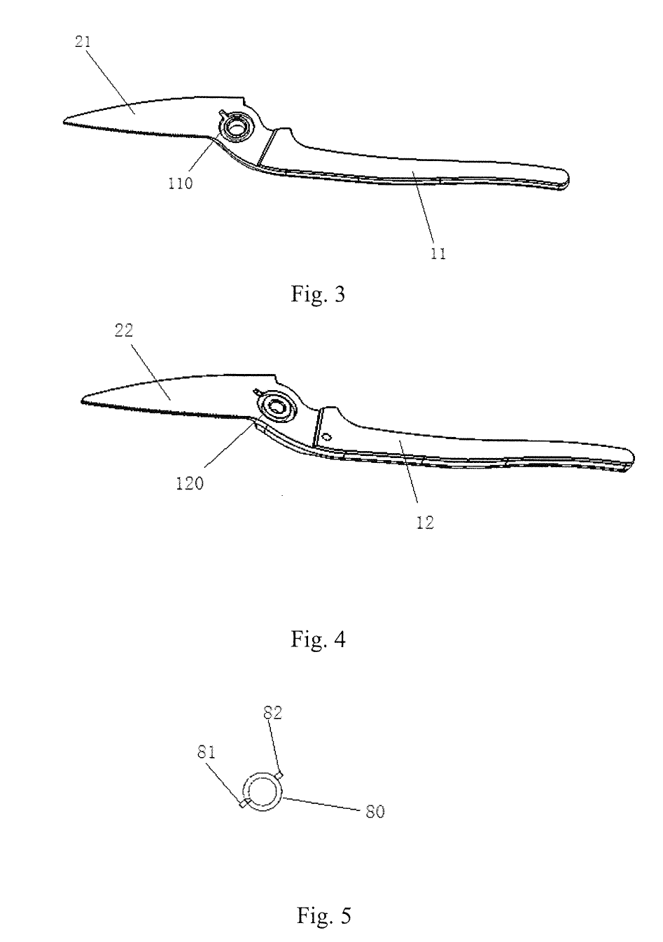

FIG. 3˜FIG. 5 show the structural schematic drawings of the torsional spring and the mating portion of a better embodiment in the present invention. In the embodiment, the torsional spring 8 located between the first scissor head 21 and the second scissor head 22 is arranged on the scissors. The torsional spring 8 cannot produce deformation without external force applied on the handle assembly, and the torsional spring 8 produces deformations when the external force applied on the handle assembly.

In the embodiment, the torsional spring 8 includes a ring-shaped part 80, a first extension 81 and a second extension 82. A first groove 110 is arranged on the first scissor head and a second groove 120 is arranged on the second scissor head. A part of the ring-shaped part 80 of the torsional spring and the first extension 81 are embedded in the first groove 110. The other part of the ring-shaped part 80 of the torsional spring and the second extension 82 are embedded in the second groove 120.

In the embodiment, a built-in torsional spring is arranged on the scissors provided in the present invention, which makes the torsional spring less easy to damage with a simple entire shape and a compact structure. When shearing objects, a proper force applied on the first handle and the second handle is sufficient to overcome the resistance of the spring, which is comfortable to use. After ceasing the force on the handle assembly, the torsional spring restores to the original shape, in order to separate the first scissor head and the second scissor head for next operating.

In the better embodiment of the present invention, a positioning member 9 with a first end 91 and a second end 92 is arranged on the second scissor head 22 or the second handle 12. The first end 91 of the positioning member 9 is pivotally connected with the second scissor head 22 or the second handle 12. When the second end 92 is aligned with the first scissor head 21 and the second scissor head 22, the second end 92 of the positioning member 9 mounted to rotate about the first end 91 and against the first scissor head 21, preventing the first scissor head 21 to rotate. When the scissors are not used, the positioning member 9 facilitates placing the scissors to prevent scratching. FIG. 6 shows a pair of scissors provided with the positioning member in which the first end 91 and the second scissor head 22 are pivotally connected via the pivot structure 10. The handle assembly of the scissors shown in FIG. 6 also includes a coating layer, which increases comfort when an operator uses

The ongoing description details the preferable embodiments of the invention. It should be understood that with the general technique of this field, no inventive work is necessary as to make multiple amendments and changes according to conception of this invention. Therefore, all the technical schemes gained from logical analysis, deductions or limited experimentation based on the present invention by technicians in this field, should be considered within the protection range asserted in the Claims.

1. A pair of scissors comprising a handle assembly and a scissor head assembly, the handle assembly comprising a first handle and a second handle, the scissor head assembly comprising a first scissor head and a second scissor head, the first scissor head with a first blade extending from an end of the first handle, the second scissor head with a second blade extending from an end of the second handle, the first scissor head and the second scissor head being pivotally hinged via a pivot structure, wherein a width-thickness ratio of the first scissor head does not exceed 8.0 at the connection portion of the scissor head assembly and the pivot structure.

2. The scissors according to claim 1, wherein the width-thickness ratio of the first scissor head does not exceed 6.0 at the connection portion of the scissor head assembly and the pivot structure.

3. The scissors according to claim 2, wherein the width-thickness ratio of the first scissor head does not exceed 4.0 at the connection portion of the scissor head assembly and the pivot structure.

4. The scissors according to claim 1, wherein a width-thickness ratio of the second scissor head does not exceed 8.0 at the connection portion of the scissor head assembly and the pivot structure.

5. The scissors according to claim 4, wherein the width-thickness ratio of the second scissor head does not exceed 6.0 at the connection portion of the scissor head assembly and the pivot structure.

6. The scissors according to claim 5, wherein the width-thickness ratio of the second scissor head does not exceed 4.0 at the connection portion of the scissor head assembly and the pivot structure.

7. The scissors according to claim 1, wherein the first scissor head and the second scissor head are manufactured by forging.

8. The scissors according to claim 1, wherein the thickness of the part located in the pivot connection portion of the scissor head assembly is 3-8 mm.

9. The scissors according to claim 8, wherein the thickness of the part located in the pivot connection portion of the scissor head assembly is 4-6 mm.

10. The scissors according to claim 9, wherein the thickness of the part located in the pivot connection portion of the scissor head assembly is 5 mm.

11. The scissors according to claim 1, wherein the first scissor head is integrated with the first handle and the second scissor head is integrated with the second handle.

12. The scissors according to claim 1, including teeth arranged on the first blade and/or the second blade.

13. The scissors according to claim 1, including a torsional spring located between the first scissor head and the second scissor head, wherein the torsional spring cannot produce deformations without external force being applied on the handle assembly, and wherein the torsional spring produces deformation when the external force is applied on the handle assembly.

14. The scissors according to claim 13, wherein the torsional spring comprises a ring-shaped part, a first extension and a second extension; a first groove is arranged on the first scissor head and a second groove is arranged on the second scissor head, a part of the ring-shaped part of the torsional spring and the first extension are embedded in the first groove, and a part of the ring-shaped part of the torsional spring and the second extension are embedded in the second groove.

15. The scissors according to claim 14, wherein the pivot structure comprises a bolt and a nut, a first hole is arranged in the first groove and a second hole is arranged in the second groove, the first hole and the second hole correspond to each other, and the bolt, fixed with nut, is arranged in the scissors through the first hole and the second hole.

16. The scissors according to claim 15, including a spacer with a through hole arranged on the pivot structure, and wherein the bolt is fixed with nut through the first hole, the second hole and the through hole of the spacer.

17. The scissors according to claim 16, wherein a concave-convex texture is arranged on the spacer.

18. The scissors according to claim 1, characterized in that, including a coating layer coated on the external of the first handle and the second handle.

19. The scissors according to claim 1, wherein a first blade and a first periphery which is opposite to the first blade are arranged on the first scissor head, and a pointed-shape head is arranged between the first blade and the first periphery; a second blade and a second periphery which is opposite to the second blade are arranged on the second scissor head, and a pointed-shape head is arranged between the second blade and the second periphery.

20. The scissors according to claim 19, wherein the width-thickness ratio of the pointed-shape head of the first scissor head does not exceed 0.5.

21. The scissors according to claim 19, wherein the width-thickness ratio of the pointed-shape head of the second scissor head does not exceed 0.5.

22. The scissors according to claim 1, wherein a first blade and a first periphery which is opposite to the first blade are arranged on the first scissor head, the thickness of the portion between the first blade and the first periphery is greater than that of the first periphery, and a second blade and a second periphery which is opposite to the second blade are arranged on the second scissor head, the thickness of the portion between the second blade and the second periphery is greater than that of the second periphery.

23. The scissors according to claim 22, wherein planes with different gradients are arranged on a portion between the first blade and the first periphery of the first scissor head from inside to outside respectively.

24. The scissors according to claim 22, wherein planes with different gradients are arranged on a portion between the second blade and the second periphery of the second scissor head from inside to outside respectively.

25. The scissors according to claim 23, wherein the planes with different gradients of the first scissor head are provided with the different width-thickness ratios.

26. The scissors according to claim 24, wherein the planes with different gradients of the second scissor head are provided with the different width-thickness ratios.

27. The scissors according to claim 23, characterized in that, wherein a first plane, a second plane, a third plane and a fourth plane with different gradients are respectively arranged on a portion, from inside to outside, between the first blade and the first periphery of the first scissor head.

28. The scissors according to claim 1, wherein a positioning member provided with a first end and a second end is arranged on the second scissor head or the second handle, the first end of the positioning member is pivotally connected with the second scissor head or the second handle, and the second end of the positioning member is arranged such that when the first scissor head is aligned with the second scissor head, the second end rotates about the first end and abuts against the first scissor head, preventing the first scissor head from rotating.
